(19) United States
(12) Patent Application Publication
(10) Pub. No.: US 2013/0216976 A1
(43) Pub. Date: Aug. 22, 2013

(54) SELF-TAPPING SCREW IMPLANT

(71) Applicant: Stefan Ihde, Uetilburg (CH)

(72) Inventor: Stefan Ihde, Uetilburg (CH)

(73) Assignee: BIOMED EST., Vaduz (LI)

(21) Appl. No.: 13/522,252

(22) PCT Filed: Jan. 13, 2011
(86) PCT No.: PCT/EP11/00113

§ 371 Date: May 1, 2013

(30) Foreign Application Priority Data
Jan. 14, 2010 (DE) 20 2010 000 915.4

(51) Int. Cl. A61C 8/00

(52) U.S. Cl. CPC A61C 8/0024
USPC 433/174

(57) ABSTRACT

The invention relates to a self-tapping screw implant, comprising a shaft, at the distal end of which a prosthetic head for receiving artificial teeth or bridges, partial or full prostheses, or the retaining constructions thereof, is provided, and at the proximal end of which a self-tapping thread having at least one half 180° turn, in particular a 360° turn, for screwing into the bone substance is provided, wherein the ratio of the outside diameter of the thread to the outside diameter of the shaft of the self-tapping screw implant ranges between 3 and 15, in particular between 4.5 and 13.5, preferably approximately 5, and the distal region of the shaft without thread and the proximal region of the shaft with thread have approximately the same or a similar axial length +/− max. 10%, and recesses are provided in the radially inner region of the turns of the thread, and the radially outer region of the thread turns and the shaft are substantially free of recesses. The aim is to further develop a mechanically highly resilient self-tapping screw implant such that it can be implanted in a minimally invasive manner with the least possible lesion of the mucous membrane, gums and bone tissue, yet ensures high-strength anchoring in the jaw bone.

The invention relates to a self-tapping screw implant for screwing into the jaw bone to accept artificial teeth or dentures according to the independent claim 1 or 4 or 6.

In prior art, a plurality of such self-tapping screw implants have been disclosed. For example:

The DE 3708638 A1 or EP 0282789 A2 by Gafelmann discloses a pin implant for dental purposes consisting of a pillar bearing provided with self-tapping thread, which pillar bearing is screwed into a pilot drill in the jaw bone, and a pillar with a shaft for attaching dental superstructures. The end of the pillar shaft is provided with a thread which is screwed into an internal thread in the pillar bearing. The length of the external diameter of the self-tapping thread does not exceed the diameter of the pillar bearing. Instead, the thread depth drops consistently to zero from the conical free end of the thread core to the pillar bearing. To facilitate self-tapping in the turns of the thread greatly offset recesses have been provided on the opposite side.

The DE 8903050 U1 discloses a screw implant for attaching dental prostheses with a threaded piece that can be screwed into the jaw bone and with an occlusal support strut which comprises a head, heck and an axial internal thread, wherein the threaded piece is designed with a consistently increasing diameter starting from its free end and is provided with an axial groove arranged between neck and free end. At the transition between the basically cylindrical neck and the polygonal head a collar with a diameter larger than the diameter of neck and head has been provided.

The DE 3735378 A1 discloses a screw implant, especially for dentures which comprises a body with an external thread that has an internal structure designed in such a way that a tool for fixation can be engaged. The body is connected with a head portion that has a smooth outer wall. The internal structure is located inside a head portion or inside the body of the implant. The head portion is open on the top, preferably round on its upper edge and aligned with an internal drill hole inside the body. Said internal drill hole extends from a level below the head portion surface normal to the level into the inside of the body. On the distal end of the implant an opening extends throughout the body. A further opening extends from the bottom of the body upwards through which bone tissue and other tissue can grow to improve adhesive strength or allow blood tissue to run out.

The DE 10055891 A1 discloses a bone screw with a threaded portion which has a tip on its first end and a head for engaging with a screw driver on its opposite second end. Said bone screw is used as a tensile element to connect pieces of bone that were damaged or torn off. To be able to fuse the screw with the bone the threaded portion has a tubular design with a plurality of recesses in its wall.

The DE 19949285 A1 discloses a bone screw which comprises a screw head and a threaded shaft, wherein an axial drill hole extends through the threaded shaft with a plurality of radial drill holes spaced from one another ending in said drill hole, wherein the axial drill hole is open on the end bearing the screw head, and wherein the radial drill holes are also open on their radially external end. In the area of the end of the threaded shaft that is situated opposite of the screw head, the axial drill hole is closed in axial direction.

The DE 3445738 A1 discloses an implant for reinforcing and/or strengthening the bone and/or for anchoring bone screws. One embodiment of the implant is designed in such a way that it can be screwed into the bone. For this purpose, it comprises on the outside an external thread and on the inside an internal thread. Furthermore, the surface of the implant is structured with slots and/or perforations. With this implant, it is possible to improve the tensile strength when anchoring bone screws.

All above-mentioned generic self-tapping screw implants disclosed in earlier prior art have a ratio of slightly above 1, for example, 1.1 and 1.3, between the external diameter of the screw thread and the external diameter of the shaft of the self-tapping screw implant. The external diameters of said screw implants also comprise a screw thread that is consistent or proximally tapered almost across the entire axial length of the shaft, resulting in weak anchorage in the bone tissue or in relatively extensive lesions of the mucous membrane and gums when the external diameters are relatively large.

Moreover, although the known self-tapping screw implants have recesses in the turns of the thread and sometimes also in the screw shaft into which bone tissue can grow, these recesses in the turns of the thread considerably weaken the strength of the self-tapping screw implant and thus the connection between implant and bone.

It is therefore the objective of the present invention to further develop a self-tapping screw implant subject to great mechanical stress in such a way that said screw implant can be implanted with minimal invasion resulting in the lowest possible level of lesions on the mucosal membrane, gums and bone tissue and, at the same, guarantee extremely strong anchorage in the jaw bone.

The characteristics described in the independent claim 1 or 4 or 6 provide a solution to the problem.

Further advantageous developments are included in the dependent claims.

The independent claims 1 and 4 and 6 show basic characteristics according to which the implant comprises a shaft which has a provision on its distal end for a prosthetics head that can receive artificial teeth or dental bridges, partial or full dentures or a support structure for these parts. In the proximal shaft portion on its external diameter a self-tapping screw thread has been provided which has at least half a 180-degree-turn, in particular 360-degree-turn, for screwing into the bone substance.

According to the independent Claim 1, a significant characteristic of the present invention is the fact that the ratio between the external diameter of the screw thread and the external diameter of the shaft of the self-tapping screw implant ranges between 3 and 15, in particular between 4.5 and 13.5, preferably amounts to approximately 5, and the distal shaft portion without screw thread and the proximal shaft portion with screw thread especially have approximately the same or a similar (max. +/− 10%) axial length.

This has the advantage that only a small hole has to be pre-drilled in the jaw bone and then the self-tapping screw implant can be easily and quickly screwed into said hole, which is very gently for bone and soft tissue. Because of the special geometry of the invention-based self-tapping screw implant, after implant placement the implant is positioned in the jawbone in such a way that the screw thread is situated in the proximal shaft portion, at least partially in lateral manner in the cortical bone substance, and that the distal shaft portion without screw thread passes through the cortical bone substance in the dental area. This ensures that the implant is anchored in the bone in the firmest possible manner, using only a minimal penetration surface.

Preferably, the screw thread on the shaft is tapered proximally, as well as conically, so that in particular only between 1 and 1.5 turns of the thread comprise approximately the maximum external diameter, and proximally and distally therefrom the screw thread ends in approximately half a turn on the external diameter of the shaft. As a result, only the radially outmost thread flanks of at least one turn, respectively, are engaged with the lateral cortical bone on the side of the tongue and on the side of the cheek, resulting in minimal lesions and maximum stability of the remaining bone substance and thus in optimal anchorage of the implant.

According to the independent Claim 4, a significant characteristic of the present invention involves that recesses with an interior width or diameter of greater than or same as 0.8 mm have been provided in the radially internal portion of several or all turns of the screw thread, and that the radially external portion of the turns and the shaft are basically free of recesses.

Preferably, the screw implant has holes in the turns of its thread through which later the bone can grow. The holes can be arranged vertically, i.e., parallel to the shaft, but they can also extend almost horizontal through the thread disc.

The edges of the holes are not flat but have pointed design, which is achieved by drilling/milling the hole not vertically but transversal. This considerably reduces the resistance originating from the walls of the hole during the process of screwing.

The recesses or holes may not be too small in order to allow the life-sustaining tissue and the bone to grow through. Depending on the thickness of the screw thread, this requires drill holes of at least 0.8 mm diameter or an interior width of greater than 0.8 mm. Thicker screw threads require greater drill holes. Furthermore, the recesses or holes should be provided in as many turns of the thread as possible or even in all turns so as to have the greatest possible area available for bone to grow through.

### Advantages:

1. Wide thread flanks can be selected according to the width of the bone. The external sides are cortically supported and not internal, soft bone of the jaw.
2. The screw threads are very sharp and self-tapping.
3. It is only required to drill a hole for the core, for example, 2.3 mm, regardless of the width of the screw thread, for example, 12 mm, the screw thread cuts through the mucous membrane and the bone.

It is of advantage to anchor the threads in the cortical (hard) area of the bone. Therefore, the implant is manufactured in different thread diameters. The shaft diameter is calculated in such a way that the shaft does not break, considering the extremely high resistances during the screw-in process. The square on the head can be connected with an insertion tool which allows for rotation. Advantageous shaft diameters range under 2.5 mm. To this end, it is important that the shaft is smooth or machine-polished or electro-polished. In any case, it should not be rough. The implant is anchored by means of the non-slip screw thread (on a macro-mechanical basis), and not on a micro-mechanical basis (for example, through a rough surface). Moreover, it would not be possible to screw the implant into the bone if it was rough, because only a maximum of 2.5 mm are drilled out and then an implant with an up to 12 mm diameter is screwed in. This, in itself, involves enormous resistances and the thread flanks have to be very sharp. In the BCS 9 dmm, the core thread height, for example, amounts to 0.9 mm, which represents an extremely small amount. After all, it has to be possible to produce the part on a machine.

According to the independent Claim 6, a significant characteristic of the present invention involves that the proximal portion of the shaft with screw thread merges in proximal direction into a tip that has a sharpened structure like that of a drill bit or ends together with the screw thread.

In front of the screw thread there is a small tip. This is the typical embodiment of prior art. In general, the tip is not always helpful. Two further, alternative sub-types should be protected:
a) Instead of said tip it comprises a sharpened structure like that of a drill bit. Said structure has the advantage that it is possible during the process of drilling to pierce the opposite cortical bone, if no respective drill hole has already been made or if such a drill hole is not positioned directly in front of the tip (for example, because the implant has moved laterally in the soft bone), or
b) There is no tip, i.e., the screw thread immediately widens. This has the advantage that the razor-sharp thread cuts on its own into the opposite cortical bone, especially when the opposite cortical bone is not flat in relation to the screw direction. The above-mentioned tip according to prior art prevents the implant from being drilled in when the drill channel has not been directly targeted during the drilling process. The (non-pointed) tip results in the fact that the cutting surfaces are spaced toward the cortical bone and the implant slips.

Subsequently, the invention is described in more detail by means of exemplary drawings which, however, should not be considered to be restricting the subject matter of the invention.

It is shown:

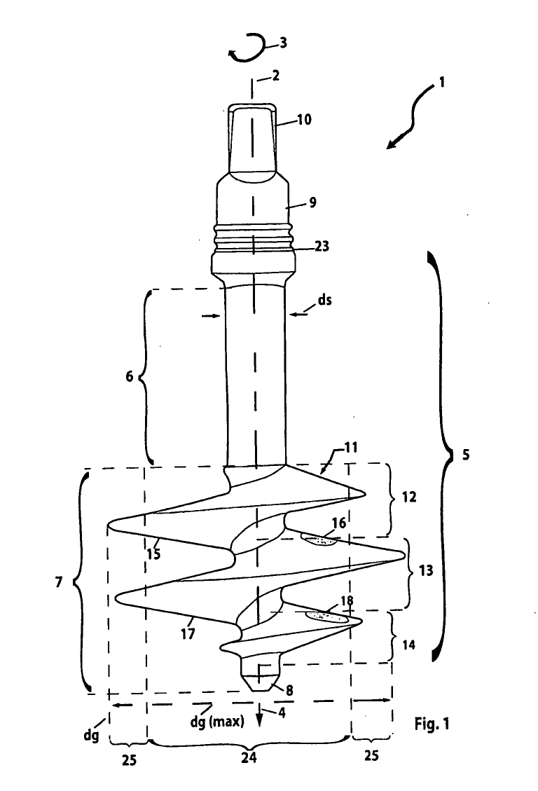

FIG. 1: a radial view of the invention-based self-tapping screw implant according to a first embodiment;

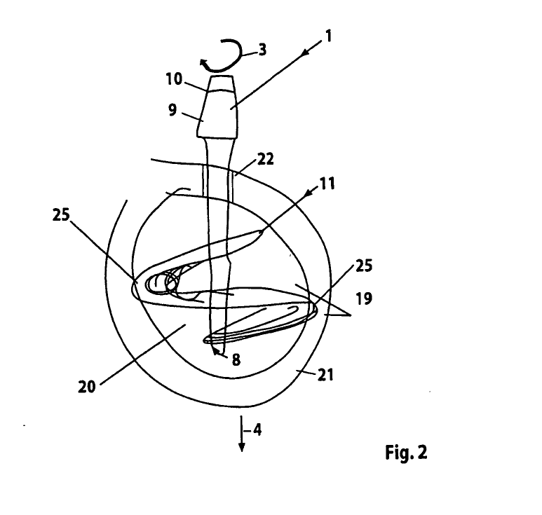

FIG. 2: a diagram of the invention-based self-tapping screw implant shown in FIG. 1 after being implanted in a jawbone;

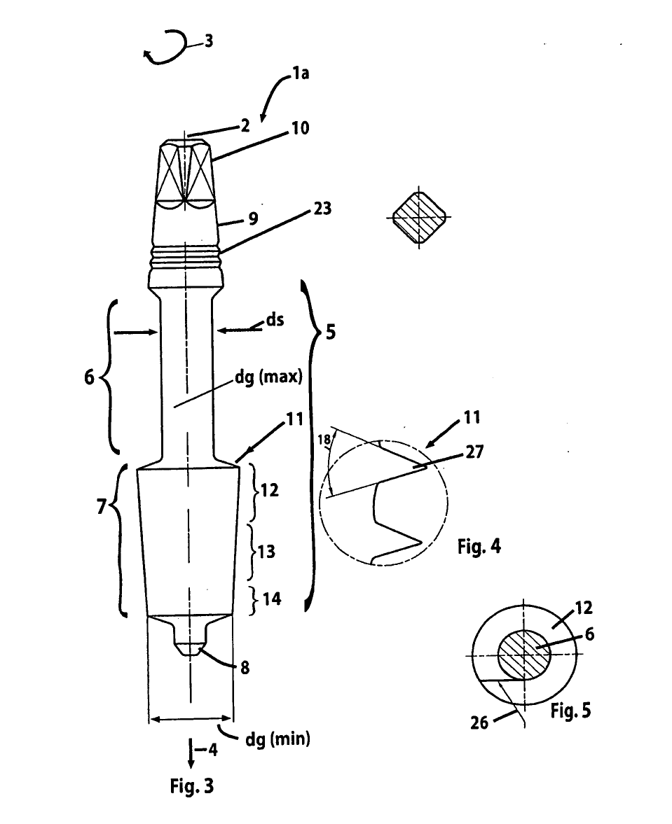

FIG. 3: a radial view of the invention-based self-tapping screw implant according to a second embodiment;

FIG. 4: a magnified radial view of a sectional cut of the screw thread of the screw implant shown in FIG. 3;

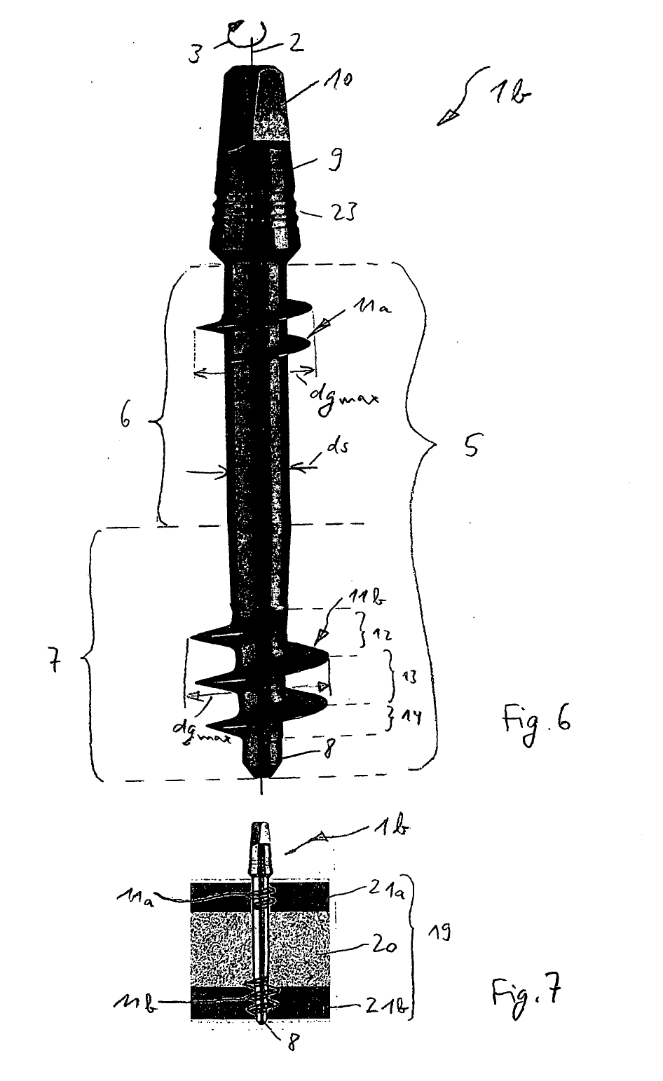

FIG. 5: a top view on FIG. 3 showing a radial cross-section through the shaft in the area between head and screw thread.

FIG. 6: a radial view on the invention-based self-tapping screw implant according tot a third embodiment;

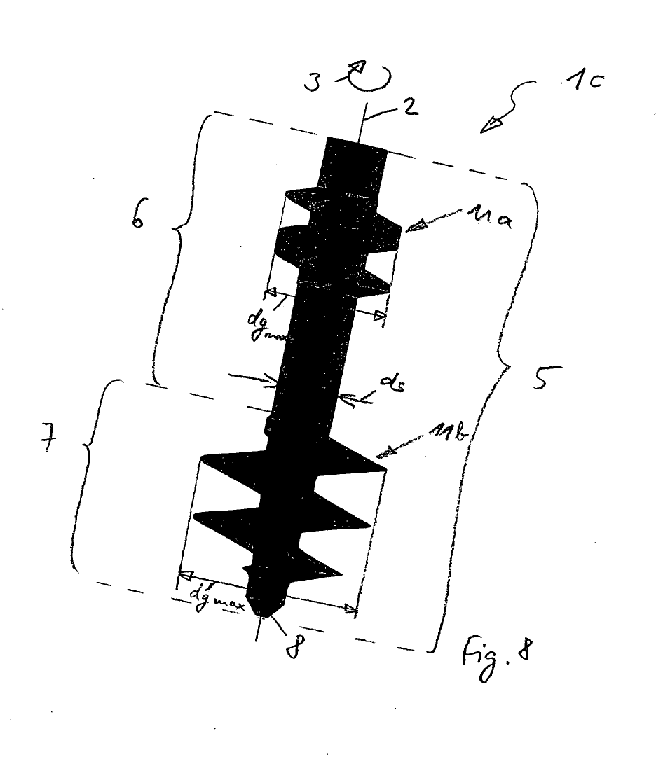

FIG. 7 a diagram of the invention-based self-tapping screw implant shown in FIG. 6 after being implanted in a jawbone;

FIG. 8 a diagram of a variant of the screw implant shown in FIG. 6.

FIG. 1 shows a first embodiment of the invention-based implant 1 in non-implanted condition. FIG. 2 shows said embodiment after being implanted in a jaw bone 19.

The implant 1 comprises a shaft 5 that is rotation-symmetrical about the axial longitudinal extension axis, which shaft is divided into two axially approximately equal parts in a distal (here upper) portion 6 (with an external diameter ds) and a proximal (here lower) portion 7. The upper shaft portion 6 has an approximately consistent external diameter ds of, in the present case, 2.5 mm. The lower shaft portion 7 extends proximally downward, is conical in shape, tapered from app. 2.75 mm to app. 1.75 mm and merges into the conical tip 8 which facilitates the insertion into the drill hole 22 in the bone 19.

The upper distal shaft portion 6 is provided with a prosthetics head 9, 10 for attaching prosthetics having a base 9 tapered conically to the distal top. The top of the base is provided with a square used as a screw back for a key tool (not shown) by means of which the implant 1 can be screwed in screw direction 3 (clockwise) into a pre-drilled drill hole 22 in the bone, with the entire implant 1 moving in feed direction 4 proximally into the bone 19.

The base 9 extends from the shaft portion 6 from app. 4 mm to app. 3.25 mm in front of the square 10, which has an edge length of app. 2.25 mm. All transitions are naturally broken, and on the outer shell of the cone of the base 9 three not very deep circumferential grooves 23 have been provided.

A screw thread 11 has been provided on the external diameter of the lower shaft portion 7. Said screw thread 11 has three turns 12-14 with a consistently decreasing downward slope (from app. 40 mm to app. 30 mm to app. 20 mm for each respective turn). Provision has also been made for an upper distal turn of the thread 12 of app. 360 degrees, followed by a further consistent medial turn 12 of app. 360 degrees, followed again by a final consistent turn 12 of app. 360 degrees. This has only exemplary significance because it is also possible to provide a different number of turns of the thread, for example, two or four, which involve at least a 180-degree-turn, preferably, however, an entire 360-degree-turn.

The upper turn of the thread 12 extends from the external diameter of the upper shaft diameter of the lower shaft portion 7 of app. 2.75 mm consistently increasing on its upper distal 180 degrees up to the maximum diameter dg (max) of in the present case app. 13.75 mm and has on its lower proximal 180 degrees the entire maximum external diameter dg (max) of in the present case 13.75 mm. The upper turn of the thread 12 descends consistently downward into the proximally following medial turn 13 which covers the maximum external diameter dg (max) of in the present case app. 13.75 mm only over app. 180 degrees. Its further lower 180 degrees decrease already in diameter to the transition diameter to the lowest proximal turn 14 of app. 9.75 mm, the external diameter of which, in turn, consistently decreases over 360 degrees to the lower shaft diameter of the lower shaft portion 7 of in the present case app. 1.75 mm.

In an axial cut parallel to the longitudinal extension, all turns of the thread 12-14 have approximately the same cross-section profile, wherein the edges of the turns of the thread 12-14 have an extremely sharp-edged design. When screwed into the bone 19, they cut the required internal screw thread in the bone 19.

Through the flanks of the turns of the thread 12-14 parallel to the longitudinal extension 2, axially extending recesses in the form of cylindrical through holes 15-18 have been placed in the radially internal portion 24 of the screw thread 11. Said recesses are circumferentially offset to one another by 180 degrees, but axially they are positioned one above the other. After implantation has been performed, in the condition shown in FIG. 2, spongy bone substance can grow through these though holes 15-18 and cause the implant 1 to stabilize. It is important that the radially external portion 25 of the screw thread 11 basically has not recesses so as not to interfere with the stability of the cutting edge of the screw thread 11.

FIG. 2 shows the implant 1 after being implanted in the bone 19.

Using a drilling tool, the drill hole 22 is first drilled through the hard cortical bone 21 on the side of the tooth into the soft spongy bone 20. Then the tip 8 of the implant 1 with the small diameter is inserted in the distal portion of this pre-drilled drill hole 22, and a wrench is placed on the square 10 of the prosthetics head and turned clockwise in screw direction 3. As a result, the entire implant moves in self-tapping manner in feed direction 4 into the jaw bone 19 and, because of the self-tapping screw thread 7 of the implant, an internal thread is cut into the bone 19. FIG. 2 shows the final position of the completed implant.

The main portion of said internal thread in the bone 19 is positioned in the spongy bone 20. However, at least two surfaces of the radially external portion 25 of the turns of the thread 12 and/or 13 of the screw thread 11 are situated, respectively, on the left side (for example, in the direction of the cheek) and on the right side (in the direction of the tongue) in the internal thread of the cortical bone 21 that has been self-tapped by the implant 1 and are there supported in load-transmitting manner.

FIGS. 3-5 show a second embodiment of an invention-based implant 1a in non-implanted condition. All identical and similar components of the implant 1 shown in FIGS. 1 and 2 of the first embodiment are provided with identical reference numerals.

Here it is clearly shown that the proximal portion 7 of the shaft 5 is tapered conically downward, just as the screw thread 11 with its three turns 12-14 positioned above. As a result, the external diameter dg of the screw thread 11 decreases in the direction of the tip 8 from a maximum external diameter dg (max), in the present case 4.6 mm, to a minimum external diameter dg (min), in the present case 3.79 mm, so that the external diameter dg of the screw thread 11 based on a length of the thread of app. 7.5 mm has an angle of app. 6.83°. The diameter of the shaft 6 amounts to app. 2.3 mm over a length of app. 8 mm. The length of the tip 8 amounts to app. 1.5 mm with a diameter of app. 1.4 mm over a length of 1 mm, wherein the last 0.5 mm to 0.4 mm diameter are pointed. The head portion 9, 10 has a length of app. 7 mm, starting with an edge length of the square 10 of 2.2 mm and a diameter of 2.3 mm to a precision diameter of +/−0.02 mm at the transition to the shaft 6.

FIG. 4 shows that the cross-section profile (screw thread profile) of the thread turns 27 of the screw thread 11 have a triangular design with three legs of equal length, and the legs of equal length comprise a turn angle (pitch angle) 28 of 40°. In the present case, the depth of the thread amounts to 1.15 mm, and in the present case the space (thread pitch) of adjacent thread turns 27 amounts to 1.74 mm.

FIG. 5 shows that at the top turn of the thread 12 the final surface of the screw thread 11 can be flat, i.e., not tapered. As a result, the implant cannot be turned back. There the top turn of the thread 12 is tangentially beveled, referring to a vertical bevel 26. In this way, the otherwise thinly tapered turn is cut and, resulting in a triangular flat surface.

Linear elevations (not shown) have been milled with an end mill or form cutter on the surface, especially on the upper surface of the screw thread 11 of the implant 1 pointing distally toward the tooth, which elevations extend approximately radially to the longitudinal axis 2 of the implant 1. In the plurality of these linear elevations, laminary recesses (not shown) are formed, which can have a planar or convex design, wherein the linear elevations merge consistently into the laminary recesses and vice versa, allowing for the implant 1 to be screwed into the bone 19 with low force without having to overcome great resistances in the form of sharp notches. The linear elevations and corresponding laminar recesses can milled into one (upper surface) or even into both surfaces (upper and lower surface) of the screw thread 11. These linear elevations have the objective of providing a self-locking reverse lock for the implant 1, wherein, however, the height differences between the linear elevations and the deepest area of the laminar recesses are relatively small. Especially during the period of wound healing, such self-locking reverse lock is important until the bone has grown into the openings and surface roughness of the implant 1.

FIGS. 6 and 7 show a further advantageous embodiment:

In this screw implant 1b, screw threads 11 are only provided where the implant is anchored in the bone tissue 19 of the cortical bone 21. In the process, the external diameter dg of the thread can be different on the top and on the bottom (in other words: on the opposite cortical bone 21b in comparison to the 1^{st} cortical bone 21a). Depending on the problem and bone density, the lower screw thread 11b can be larger than diameter dg or the upper screw thread 11a, or vice versa, or both can be equal.

It is advantageous to have no screw thread 11 on the central portion between the two threads 11a and 11b, because it is easier to move or screw the implant through the bone 19 if the thread 11 does not extend over its entire length of the screw. Different from screw that are, for example, screwed into a wall or dowel, the invention-based implants 1b allow for the possibility of changing the screw direction, especially when (after previous tooth extraction) no basic cortical bone 21a is available.

The screw threads 11a near the abutment 9 only take effect when they reach the upper cortical bone 21a, i.e., when after a tooth extraction new cortical bone forms during the process of bone healing. In the bone 19, which is hollow, load-bearing bone 20 does not form easily, which means that screw threads 11 are not required there.

FIGS. 6 and 7 also show that the distal upper thread 11a is provided with 1-1.5 turns of the thread 12-14 in the upper third of the distal portion 6 of the shaft 5. The proximal lower thread 11b, on the other hand, is provided with 2.5-3 turns of the thread 12-14 in the lower half of the proximal portion 7 of the shaft 5.

FIG. 8 shows a variant of the screw implant 1b shown in FIG. 6 in the form of the screw implant 1c.

When the upper 11a and lower thread 11b have the same thread pitch and a reduced thread diameter dg (max) the same geometric situation arises that is shown in FIG. 8. As a result, the thread 11a is flat on the outside. This does not present a disadvantage and simplifies production.

### REFERENCE NUMERALS

1. Self-tapping screw implant
2. Longitudinal axis
3. Screw direction
4. Feed direction
5. Shaft
6. Distal portion of 5
7. Proximal portion of 5
8. Proximal tip of 5
9. Base
10. Square
11. Screw thread
12. Distal turn of the thread
13. Medial turn of the thread
14. Proximal turn of the thread
15. Recess in 12
16. Recess between 12 and 13
17. Recess in 13
18. Recess in 14
19. Jaw bone
20. Spongy bone substance
21. Cortical bone substance
22. Drill hole in bone 19
23. Circumferential groove in 9
24. Radially internal portion of 11
25. Radially external portion of 11
26. Tangentially vertical bevel in 12
27. Thread turns
28. Turn angle
29. dg=external diameter of the screw thread 11
30. dg (max)=maximum external diameter of the screw thread 11
31. dg (min)=minimum external diameter of the screw thread 11
32. ds=external diameter of the shaft 5 in the distal portion 6

1. The self-tapping screw implant including a shaft, at the distal end of the distal portion is a prosthetic head for the reception of artificial teeth or dental bridges, partial or full dentures or their
retaining structures is provided at its proximal end region a self-tapping thread having at least half a 180°-thread, in particular 360 °-thread to be screwed into bone substance is provided, characterized in that the ratio the outside diameter (dg) of the thread for outside diameter (ds) of the shaft between 1, 5 and 15, in particular 3.5 to 10, preferably up to approximately 5 to 6.

2. An implant according to claim 1, characterized in that the radially inner region of several or all threads of the thread recesses with a clear width or diameter greater than or equal to 0.8 mm are provided.

3. An implant according to claim 1, characterized in that the radially outer region of the threads, and the shaft itself free of recesses are.

4. The self-tapping screw implant including a shaft, at the distal end of the distal portion is a prosthetic head for the reception of artificial teeth or dental bridges, part or full dentures, or their
retaining structures is provided at its proximal end region a self-tapping thread having at least half a thread turn 180°, in particular 360°-thread to be screwed into bone substance is provided, characterized in that the radially inner region of several or all threads of the thread has recesses with clear width or diameter greater than or equal to 0.8 mm are provided, and that the radially outer region of the threads, and the shaft itself substantially free of recesses are.

5. An implant according to claim 4, characterized in that the ratio of the outside diameter (dg) of the thread to the outside diameter (ds) of the shaft between 1, 5 and 15 is, in particular 3.5 to 10, preferably up to approximately 5 to 6.

6. The self-tapping screw implant including a shaft, at the distal end of the distal portion is a prosthetic head for the reception of artificial teeth or dental bridges, partial or full dentures or their
retaining structures is provided at its proximal end region a self-tapping thread having at least half a 180°-thread, in particular 360°-thread to be screwed into bone substance is provided, characterized in that the proximal region of the shaft with the thread in the proximal direction either in a tip passes, which has a like a drill sharpened structure, or together with the thread ends.

7. An implant according to claim 1, characterized in that the distal region of the shaft without thread has an axial length in the direction of longitudinal axis of between 2 mm and 24 mm and the proximal region of the shaft having threads has an axial length in the direction of longitudinal axis between 4.5 mm and 7.5 mm, and in particular, the distal region and the proximal region is about the same or similar axial length +/− max. 10%.

8. An implant according to claim 1, characterized in that the threads of the thread on the shaft both at the proximal end, and taper at the distal end of the thread is conical, reduced thus continuous radially.

9. An implant according to claim 8, characterized in that the threads 180° at least over the maximum outside diameter (dg (max)), and proximal and distal to it ever run out at roughly the shaft outside diameter (ds).

10. An implant according to claim 1, characterized in that the recesses through holes are disposed axially parallel and/or almost radially to the longitudinal extension of the shaft by the threads go.

11. An implant according to claim 1, characterized in that the shaft has a max. outside diameter (ds) between 0.9 to 2.5 mm, typically comprises 2.1 to 2.3 mm and the max. Outside diameter (dg (max)) of the thread from 3.5 to 15 mm, typically is 12 mm.

12. An implant according to any claim 1, characterized in that the shaft has a low surface roughness features.

13. An implant according to claim 1, characterized in that the implant of at least one metal material or at least one metal alloy.

14. An implant according to claim 1, characterized in that the recesses into the threads by mechanical and/or thermal and/or electromechanical/electrochemical methods are introduced.

15. An implant according to claim 1, characterized in that the implant is a casting or sintered part and the recesses introduced by releasable mold cores into the threads.

16. An implant according to claim 1, characterized in that at the uppermost thread, the final page of the thread is flat, not so expires pointed.

17. An implant according to claim 1, characterized in that the thread profile is triangular with an angle is between 20° and 50° and the pitch of the thread is between 1 and 2.

18. An implant according to claim 1, characterized in that in the distal top and/or underside of the proximal thread of the implant has a plurality of, in particular approximately radially extending line portions are provided, which is continuous in.

19. An implant according to claim 1, characterized in that the proximal region of the shaft with the thread in the proximal direction into a tip passes, which has a structure like a drill sharpened.

20. An implant according to claim 1, characterized in that the proximal region of the shaft with the thread in proximal direction together with the thread ends.

21. An implant according to claim 1, characterized in that in addition to self-tapping thread in the proximal region of the shaft also in the distal region of the shaft is a particular self-cutting thread with at least half a thread turn 180°, in particular 360°-thread for screwing into the bone substance is provided.

22. An implant of claim 21, characterized in that the distal thread and the proximal thread (b) identical or different pitches and/or outside diameter (dg) and/or number of threads and/or shape and angle of the thread convolutions.

23. An implant according to claim 21, characterized in that the distal thread is flattened radially outwardly self-tapping but not in the axial direction.
